(19) United States
(12) Patent Application Publication
(10) Pub. No.: US 2011/0096150 A1
(43) Pub. Date: Apr. 28, 2011

(54) METHOD AND APPARATUS FOR THE OPTICAL CHARACTERIZATION OF SURFACES

(75) Inventors: Sipke Wadman, Eindhoven (NL); Johan Bosman, Eindhoven (NL)

(73) Assignee: KONINKLIJKE PHILIPS ELECTRONICS N.V., EINDHOVEN (NL)

(21) Appl. No.: 12/673,512

(22) PCT Filed: Aug. 14, 2008
(86) PCT No.: PCT/IB08/53268

§ 371 Date: Feb. 15, 2010

(30) Foreign Application Priority Data
Aug. 22, 2007 (EP) 07114781.3

(51) Int. Cl. H04N 13/02

(52) U.S. Cl. 348/49; 348/E13.074

(57) ABSTRACT

The invention relates to a method and an apparatus for the optical characterisation of a three-dimensional surface. The method and apparatus are an improvement over the known photogoniometer and Parousiameter, as it enables a more reliable characterisation of three-dimensionally shaped surfaces. The technique is particularly useful for the characterisation of surfaces with a complex optical appearance such as the human skin.

### FIELD OF THE INVENTION

The invention relates to a method and an apparatus for the optical characterisation of a three-dimensional surface.

### BACKGROUND OF THE INVENTION

A camera can capture an image of a subject that is illuminated by a light source. The type of image that is formed, depends on the direction of illumination and on the viewing angle of the camera. The yellow beam illuminates the sample under an illumination angle and the camera captures the image of the sample under a viewing, capturing light reflected and dispersed by the surface. Both the viewing angle and the illumination angle can be characterized with a height B and an azimuth value φ that are angles measured with respect to a normal direction protruding from the surface of the subject.

For the characterization of optical properties of a surface, it is necessary that the illumination angles (θin, φlv) and viewing angles (θout, θout) are well controlled over the area of measurement. In this sense a BRDF of a surface can be determined with a photogoniometer or a Parousiameter, but it requires that the surface under test is essentially flat, because any undulations will form uncertainties in both viewing angles. If the sample is warped or if it has a real three-dimensional form, there is a great range of angles for illumination and viewing, making it very difficult to control the viewing angles and illumination angles. In the case the surface of the sample is provided with an unregular, undefined surface, such as the human skin, the situation is even more complicated and the known techniques, in particular the photogoniometer and the Parousiameter, are found to be lacking.

It is an object of the invention to improve the optical characterisation of three dimensionally shaped surfaces.

### SUMMARY OF THE INVENTION

The invention provides a method for the optical characterisation of a three-dimensional surface, comprising the steps of A) providing an object having a three-dimensional surface, B) three-dimensional mapping of at least part of the surface as interconnected surface portions, wherein for each surface portion to be characterized a normal direction is determined, C) positioning at least one light source at a predetermined position with respect to the surface portion, aimed towards the surface under a predetermined illumination angle of the light from the light source with respect to the normal direction, D) positioning of at least one optical recording means with respect to the surface portion, under a predetermined viewing angle with respect to the normal direction of the light from the light source reflected by the surface portion towards the optical recording means, and E) optical recording of the light from the light source reflected by the surface portion. Thus, it is possible to do an optical recording of a three-dimensional surface while controlling the illumination angle and viewing angle. The illumination angle is defined by two perpendicular angles, measured with respect to the normal direction; the illumination height and the illumination azimuth. Comparably, the viewing angle is defined by a viewing height and a viewing azimuth. The position of the object is preferably determined by an object holder, allowing for control of the position of the three-dimensional surface. The three-dimensional mapping of the surface may be done by for instance laser measurement equipment, storing a three-dimensional model in digital form to determine surface portions. Smaller surface portions will give a more accurate determination of the normal direction, but also require more processing power. The surface portions in themselves are considered to be flat, but are chosen to be small enough to match the curved three-dimensional surface. The position of the light source and optical recording means relative to the object may be done by keeping the object in a fixed position while moving the light source and/or the optical recording means, but it is also possible to move and/or rotate the object.

The light source may be any preferred light source, and preferably has a direction and only shows little convergence or divergence. The typical optical recording means comprise a digital camera connected to digital storage means, that are programmed to store the digitally recorded picture as well as the used parameters, in particular the relative positions of the object, light source and camera.

Preferably, step E) is repeated for a number of predetermined illumination angels and/or viewing angles. Thus, more information is gathered on the optical properties of the surface such as reflectivity, colour and texture under various angles. This allows for a more reliable digital reproduction of the recorded surface.

In a preferred embodiment, the predetermined illumination angle is kept constant and the viewing angle is varied. Thus, optical parameters are easily determined.

Alternatively, the predetermined viewing angle is kept constant and the illumination angle is varied. This has the advantage of a faster work flow, as the camera does not need to refocus and the light source can be relocated faster. More preferably, instead of moving a single light source, a plurality of light sources is used, at a plurality of positions with respect to the object is used. Rather than moving a single light source, one light source is turned on, an image is recorded, the light source is turned off and another light source at a different location is turned on for another recording of the image, but at another illumination angle. This method is particularly advantageous for transparent or semi-transparent surfaces, such as the human skin.

Preferably, during at least one of the optical recordings, the viewing angle coincides with the normal direction. This gives the maximum area of a particular surface portion.

In a preferred embodiment, the viewing angle is varied from 0° to 45°. This gives most information reflected from the surface portion.

It is advantageous if the illumination angle is at between 90 and 80 degrees with the normal direction. Such lighting at a grazing angle gives most texture details, in particular if viewing angle is close to the normal direction. Depending on the chosen axis, the angles between −90 and −80 are equivalent to the angles between 90 and 80 degrees. Preferably, the viewing angle approximately coincides with the normal direction, but may range from 45 to −45 degrees with the normal direction.

Preferably, the steps C, D and E are repeated for a number of adjacent surface portions. Thus, a reliable texture can be determined for an area covering multiple adjacent surface portions.

Preferably, the surface is divided in polygonal surface portions. Polygon surface portions facilitate easier calculation and modelling of textures.

Most preferably, the surface is divided in triangular surface portions. Triangular surface portions make texture calculations relatively easy.

In a preferred embodiment, a first set of optical recordings is collected by repeating step E) multiple times under different illumination angles and viewing angles, followed by step F): the combination of the first set of optical recordings of a surface portion to yield a first combined image characterisation of the surface portion. Hence, a very reliable texture can be calculated and reproduced from the combined image characterisation. The optical recordings may for instance be combined by superimposing the optical recordings, preferably a weighted superimposing wherein specific areas of interest of the surface portion for each optical recording are weighted relatively strongly. The combined images may for instance be used for classification of surfaces.

Preferably in step F) the combined image characterisation of the surface portion is projected onto a corresponding surface portion of a digitalized three-dimensional model of the object. This yields a very realistic reproduction of the three-dimensional surface of the recorded object, and may for instance be used to obtain a very realistic skin texture on a digital model of a person.

In another preferred embodiment, after a predetermined time interval from the recording the first set of optical recordings in step F) subsequently step G) is performed, involving the recording of a second set of optical recordings and the combination of the first set of optical recordings of a surface portion to yield a second combined image characterisation of the surface portion. Preferably, the second set of optical recordings is performed under essentially the same illumination angles and viewing angles as the first set, and then combined to yield a second combined image characterisation of the surface portion that enables a reliable comparison of the characterisations. Thus, it is possible to record changes in the surface over time. Sets of optical recordings may for instance be collected after a number of hours, days, weeks or months. It may be regularly repeated to see the changes in the surface over time, for instance due to wear. When the image characterisation is taken from an object that also changes geometry over time, such as the skin of a living person or animal, it is advantageous to correct the image characterisation for 3D geometry. For instance if the surface is a persons skin, the persons may become fatter or slimmer between image characterisations that are taken over weeks, months or years.

It is advantageous if during the time interval, the object undergoes a treatment. Thus, the influence of the treatment on the appearance of the surface becomes clear by this method. The treatment may for instance be a surface treatment, the application of a certain substance to the surface portion, and may for instance reveal wear or degradation of the surface. The method is particularly suitable for studying difficult surfaces such as the human skin, and may for instance be used to investigate the effect of certain cosmetic products applied to the skin.

Advantageously, step G is followed by step H), comparing the first combined image characterisation to the second combined image characterisation. In this way differences between the surfaces before and after the time interval may be compared. This may be done qualitatively, but also quantitatively, for instance for instance using digital image subtraction methods known in the art.

In a preferred embodiment the three-dimensional surface is human skin. The surface of the human skin (as well as comparable skins of other living creatures) is particularly hard to characterize by known methods, but the method according to the invention yields very good results and yields surface information not accessible by methods known in the art.

The invention also provides an apparatus for the optical characterisation of a surface, comprising an object holder for holding an object at a predetermined location in a predetermined orientation, at least one light source for directing light at the object under an illumination angle, at least one optical recording means for capturing light reflected from the object under a viewing angle, and positioning means for varying the mutual positions and orientations of the object, the light source and the optical recording means, wherein the light source, optical recording means and positioning means are connected to controlling means programmed to perform the method according to any of the preceding claims. The object holder can for instance be an adjustable head-holding device. The predetermined location and predetermined orientation may be determined by the position and orientation of the object holder, but may also be determined by optical or acoustic means. The light source may be any suitable lamp, for instance lamps commonly used in photography. Multiple lamps may be used in order to speed up the process, as instead of moving the light and/or the object, various angles can also be obtained by switching different lights in different positions on and off. The optical recording means are typically digital cameras capable of recording at high resolutions, either in separate shots or continuously. The optical recording means may comprise more than one camera, wherein cameras at different positions can be used simultaneously in order to speed up the process. The positioning means may involve any mechanical or electrical means capable of moving or rotating the light source, camera and/or object. The controlling means typically comprise one or more microprocessors.

In a preferred embodiment the apparatus also comprises viewing means for viewing the optical recordings. The viewing means may be any screen or projecting means.

### BRIEF DESCRIPTION OF THE DRAWINGS

FIG. 1 shows an apparatus according to the invention.

FIG. 2 shows a modelled three-dimensional shape according to the invention.

### DETAILED DESCRIPTION OF EMBODIMENTS

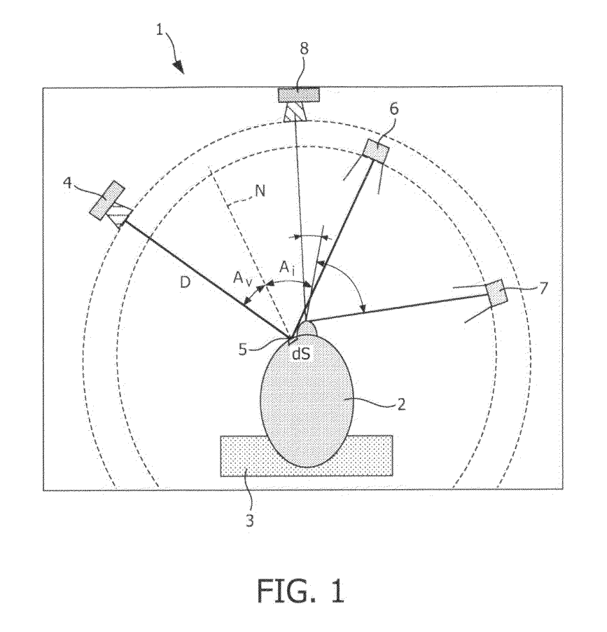

FIG. 1 shows an apparatus 1 according to the invention, comprising an object 2, in this case a human head, whose position is fixed by an object holder 3. The three-dimensional shape of the head was predetermined by traditional laser methods as for instance described in U.S. Pat. No. 5,870,220 and stored in the controlling means of the apparatus 1. A camera 4 mounted on a robot arm (not shown) is positioned at an exactly known distance D and exactly known viewing angle Aᵥ as measured from the normal direction N of the surface portion 5 to be determined by comparing to the stored model. A light source 6, also mounted on a robot arm, is positioned at a distance I under an illumination angle Aᵢ, reflecting light from the surface 5 of the object 2 to be captured by the camera 4. Optionally, a second light source 7 and/or a second camera 8 may be employed, in order to speed up the process.

The three-dimensional mapping of at least part of the surface of the object 2 as interconnected surface portions 5, each having its own normal direction N, determines the viewing angles and illumination angles under which the camera 4 and light source 7 are positioned. Multiple images of each surface portion 5 are taken under different viewing angles Aᵥ and illumination angles Aᵢ. The recorded images are combined to yield a thorough optical characterization of each surface portion 5. Various algorithms can be used to combine the images. The characterization can be used to compare skin portions of the head 2. Making characterizations before and after applying for example a skin cream to the head 2, the influence of the cream or tanning irradiation on optical appearance of the skin, in particular wrinkles colour and reflectivity, can be determined more thoroughly than in known methods.

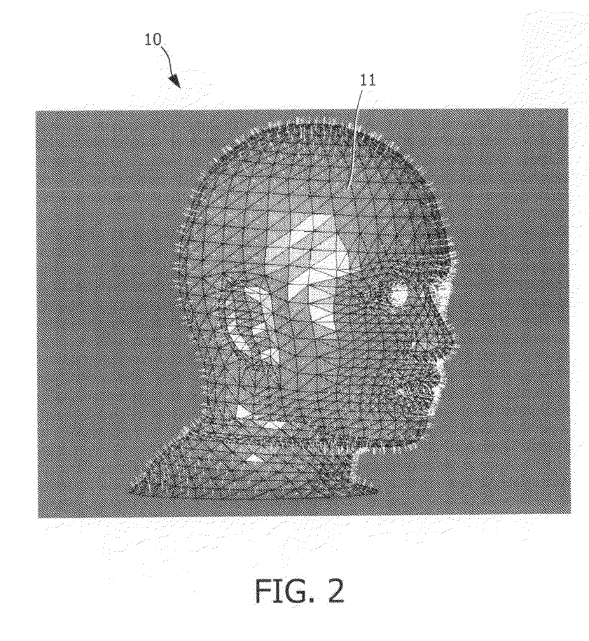

FIG. 2 shows a three-dimensional model 10 divided in triangular skin portions 11 each defining its own normal direction. For each of these skin portions an optical characterisation is made according to the method described for FIG. 1. Thus, the influence of any skin treatment can be easily determined by comparing skin portions of interest before and after the treatment.

In addition it will be appreciated that the method as described above can, when suitably programmed, be sold to the market in the form of a computer programming product. The program stored thereon can when executed on a processing device (such a CPU of a personal computer or a PDA) carry out the method as described above.

1. Method for the optical characterization of a three-dimensional surface, comprising the steps of:
A) providing an object having a three-dimensional surface,
B) three-dimensional mapping of at least part of the surface as interconnected surface portions, wherein for each surface portion to be characterized a normal direction (N) is determined,
C) positioning at least one light source at a predetermined position with respect to the surface portion, aimed towards the surface under a predetermined illumination angle (Aᵢ) of the light from the light source with respect to the determined normal direction of the surface portion, and
D) positioning of at least one optical recording means with respect to the surface portion, under a predetermined viewing angle (Aᵥ) with respect to the determined normal direction of the light from the light source reflected by the surface portion towards the optical recording means,
E) optical recording of the light from the light source reflected by the surface portion.

2. The method according to claim 1, wherein
the step of optical recording is repeated for a number of predetermined illumination angles and/or viewing angles.

3. The method according to claim 2,
wherein the predetermined illumination angle is kept constant and the viewing angle is varied.

4. The method according to claim 2,
wherein the predetermined viewing angle is kept constant and the illumination angle is varied.

5. The method according to claim 1,
further comprising during at least one of the optical recordings, the viewing angle coincides with the normal direction.

6. The method according to claim 1, wherein the viewing angle is varied from 0° to 45°.

7. The method according to claim 1,
wherein the illumination angle between 90 and 80 degrees with the normal direction.

8. The method according to claim 1,
wherein the steps C, D and E are repeated for a number of adjacent surface portions.

9. The method according to claim 1, wherein the surface is divided in polygonal surface portions.

10. The method according to claim 9, wherein the surface is divided in triangular surface portions.

11. The method according to claim 1, wherein a first set of optical recordings is collected by repeating step E) multiple times under different illumination angles and viewing angles, and then followed by step F): the combination of the first set of optical recordings of a surface portion to yield a first combined image characterization of the surface portion.

12. The method according to claim 11, wherein
the combined image characterization of the surface portion is projected as a onto a corresponding surface portion of a digitalized three-dimensional model of the object.

13. The method according to claim 11,
wherein after a predetermined time interval from the recording the first set of optical recordings in step F) subsequently step G) is performed, involving the recording of a second set of optical recordings and the combination of the first set of optical recordings of a surface portion to yield a second combined image characterization of the surface portion.

14. The method according to claim 13,
wherein during the time interval of step G, the object undergoes a treatment, preferably a surface treatment.

15. The method according to claim 14, further comprising, following step G step H), comparing the first combined image characterization to the second combined image characterization.

16. The method according to claim 1, wherein the three-dimensional surface is human skin.

17. An Apparatus for the optical characterization of a surface, comprising
an object holder for holding an object at a predetermined location in a predetermined orientation,
at least one light source for directing light at the object under an illumination angle (Aᵢ),
at least one optical recording means for capturing light reflected from the object under a viewing angle (Aᵥ),
positioning means for varying the mutual positions and orientations of the object, the light source and the optical recording means, and
controlling means, connected to the light source, optical recording means and positioning means, the controlling means being programmed to perform the method according to claim 1.

18. The apparatus according to claim 17,
further comprising viewing means for viewing the optical recordings.

19. A Computer programming product containing code stored thereon that when executed by a processing device is arranged to carry out the method of claim 1.
